(19) United States
(12) Patent Application Publication
(10) Pub. No.: US 2006/0091176 A1
(43) Pub. Date: May 4, 2006

(54) Cordless fastening tool nosepiece with integrated contact trip and magazine feed

(76) Inventors: Michael F. Cannaliato, Bel Air, MD (US); Terry L. Turner, Westminster, MD (US); Luis A. Guanzon, Joppa, MD (US); Richard J. Heavel, Hanover, PA (US); Thomas Wheeler, Pomona, CA (US)

Correspondence Address: HARNESS, DICKEY & PIERCE, P.L.C., P.O. BOX 828, BLOOMFIELD HILLS, MI, 48303, US

(21) Appl. No.: 10/978,867

(22) Filed: Oct. 29, 2004

(51) Int. Cl. B25C 1/00

(52) U.S. Cl. 227/8; 227/131; 227/142

(57) ABSTRACT

A fastening tool that inserts a fastener into a work-piece includes a trigger and an actuation member connected to the trigger. The fastening tool further includes a trigger switch and a trigger block. The trigger block has a blocked position that inhibits the actuation member from actuating the trigger switch. The trigger block also has an unblocked position that does not inhibit the actuation member from actuating the trigger switch. The mechanical contact trip mechanism provides a contact trip without the need for additional switches and a complicated trigger assembly.

### FIELD OF THE INVENTION

The present invention relates to a cordless fastening tool and more specifically to a nosepiece with an integrated mechanical contact trip.

### BACKGROUND OF THE INVENTION

Traditional fastening tools can employ pneumatic actuation to drive a fastener into a work-piece. In these tools, air pressure from a pneumatic system can be utilized to both drive the fastener into the work-piece and to reset the tool after driving the fastener. It will be appreciated that in the pneumatic system a hose and a compressor are required to accompany the tool. To that end, a combination of the hose, the tool and the compressor provides for a large, heavy and bulky package that is relatively inconvenient and cumbersome to transport.

One alternative to a tool that requires a pneumatic system are tools that employ combustion systems for generating power to drive a fastener into a work-piece. These tools typically hold a combustible propellant and have a battery that is employed to produce a spark for igniting the combustible propellant. Expanding combustion gases are used to drive the fastener. Additional propellant canisters, therefore, must be carried to ensure continued use of the fastening tool. Moreover, the combustion system can exhaust combustion gases in close proximity to the user.

In view of the drawbacks of traditional pneumatically powered fastening tools and fastening tools that employ combustible propellants, battery-powered fastening tools have been developed, such as the DeWalt DC612KA and DC618KA finish nailers. Like the tools that employ combustible propellants, these battery-powered fastening tools can utilize an electronic sensor to detect when a contact trip is pressed against the work-piece. In other examples, the fastening tool can use a complex trigger assembly to integrate the contact trip mechanism into a trigger. It will be appreciated that additional sensors and complex trigger assemblies add to the complexity and cost of the cordless fastening tool.

### SUMMARY OF THE INVENTION

A fastening tool that inserts a fastener into a work-piece includes a trigger and an actuation member connected to the trigger. The fastening tool further includes a trigger switch and a trigger block. The trigger block has a blocked position that inhibits the actuation member from actuating the trigger switch. The trigger block also has an unblocked position that does not inhibit the actuation member from actuating the trigger switch.

Further areas of applicability of the present invention will become apparent from the detailed description provided hereinafter. It should be understood that the detailed description and specific examples, while indicating the various embodiment of the invention, are intended for purposes of illustration only and are not intended to limit the scope of the invention.

### BRIEF DESCRIPTION OF THE DRAWINGS

The present invention will become more fully understood from the detailed description, the appended claims and the accompanying drawings, wherein:

FIG. 1 is a perspective view of an exemplary cordless fastening tool constructed in accordance with the teachings of the present invention showing an exemplary fastener and an exemplary work-piece;

FIG. 2 is similar to FIG. 1 and shows a transmission, a driver mechanism and a control module;

FIG. 3 is a partial perspective view of the fastening tool of FIG. 1 and shows the transmission and the driver mechanism including a crank link track and the crank link return-spring;

FIG. 4 is a partial perspective view of the fastening tool of FIG. 1 and shows the driver mechanism and the transmission including a flywheel, a cam gear, a first drive gear and a second drive gear;

FIG. 5 is a partial front view of the transmission showing the flywheel and the cam gear prior to engagement with a clutch pin;

FIG. 6 is similar to FIG. 4 and shows the transmission prior to engagement with the driver mechanism;

FIG. 7 is similar to FIG. 5 and shows a ramp on the cam gear in contact with the clutch pin;

FIG. 8 is similar to FIG. 6 and shows the driver mechanism in a bottom position;

FIG. 9A is a perspective view of a magazine front of a nosepiece constructed in accordance with the teachings of the present invention;

FIG. 9B is a cross-sectional view of FIG. 9A showing a slide formed in the magazine front;

FIG. 10 is a perspective view of a fastener magazine showing a nosepiece cover flipped open;

FIG. 11 is an exploded assembly view of a contact trip mechanism constructed in accordance with the teachings of the present invention;

FIG. 12 is a front view of the contact trip mechanism in a extended position;

FIG. 13 is a front view of the contact trip mechanism of FIG. 12 showing the contact trip mechanism in a retracted position;

FIG. 14A is a perspective view of a trigger switch, a trigger actuation member and a trigger block in a blocked position; and

FIG. 14B is similar to FIG. 14A and shows the trigger block in an unblocked position and the trigger actuation member contacting the trigger switch.

### DETAILED DESCRIPTION OF THE VARIOUS EMBODIMENTS

The following description of the various embodiments is merely exemplary in nature and is in no way intended to limit the invention, its application or uses.

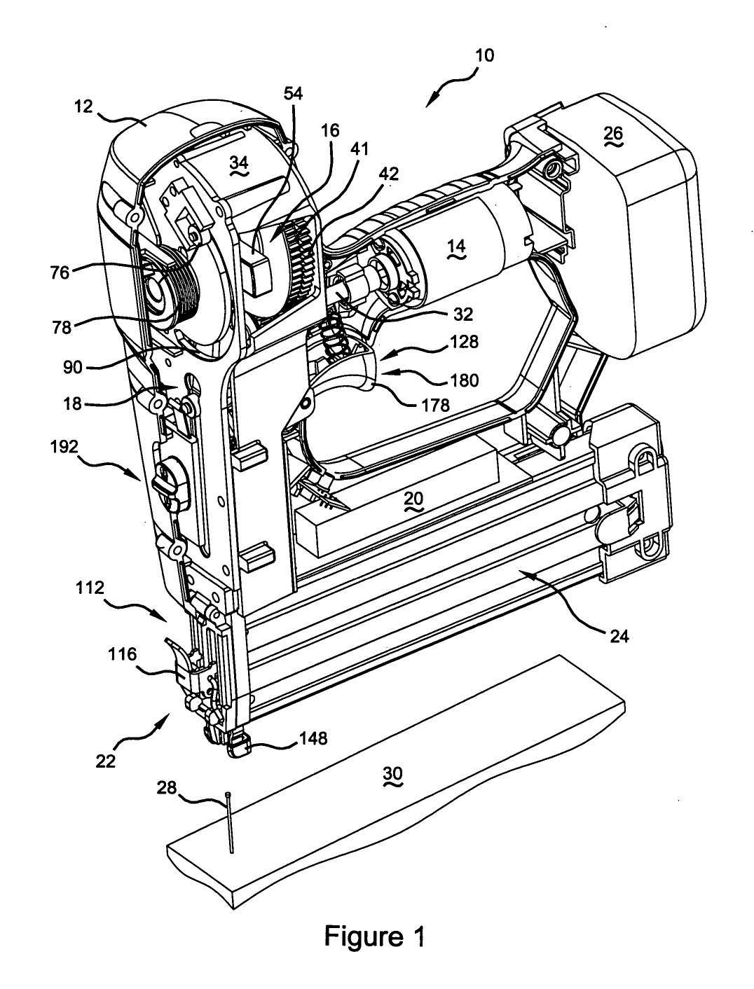

With reference to FIG. 1, an exemplary fastening tool constructed in accordance with the teachings of the present invention is shown and generally indicated by reference numeral 10. The fastening tool 10 can include an exterior housing 12, which can house a motor 14, a transmission 16, a driver mechanism 18 and a control module 20. The fastening tool 10 can also include a nosepiece 22 and a fastener magazine 24 and a battery 26. The fastener magazine 24 can be coupled to the driver mechanism 18, while the battery 26 can be coupled to the exterior housing 12. The motor 14 can drive the transmission 16, which in turn can actuate the driver mechanism 18. Actuation of the driver mechanism 18 can drive fasteners 28, which are sequentially fed from the fastener magazine 24 into the nosepiece 22, into a work-piece 30. The fasteners 28 could be nails, staples, brads, clips or any such suitable fastener that could be driven into the work-piece 30.

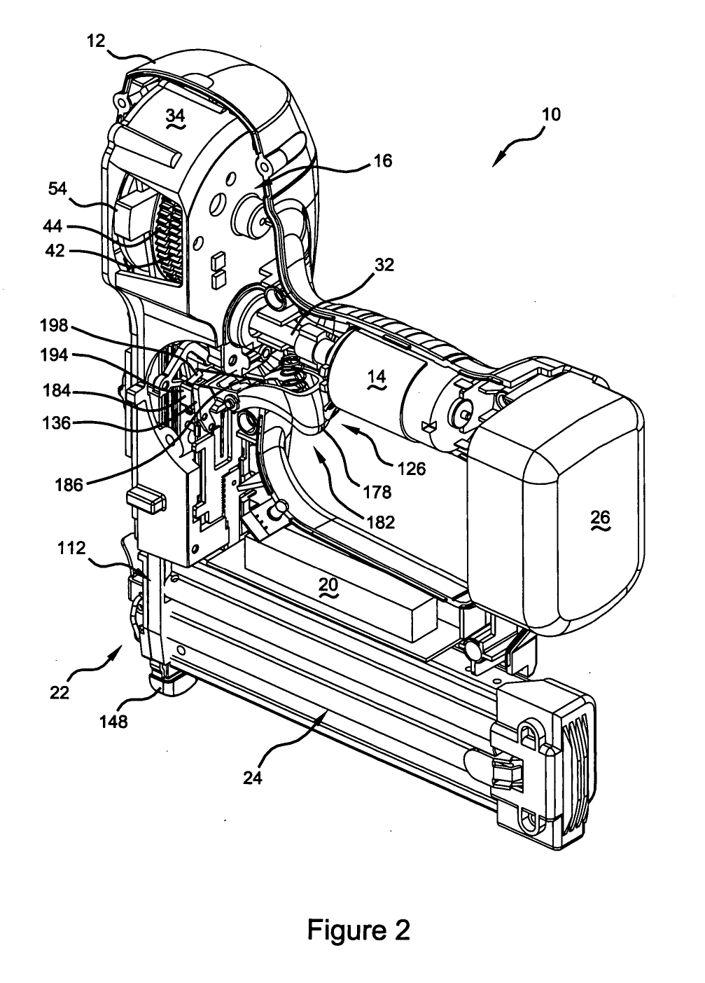

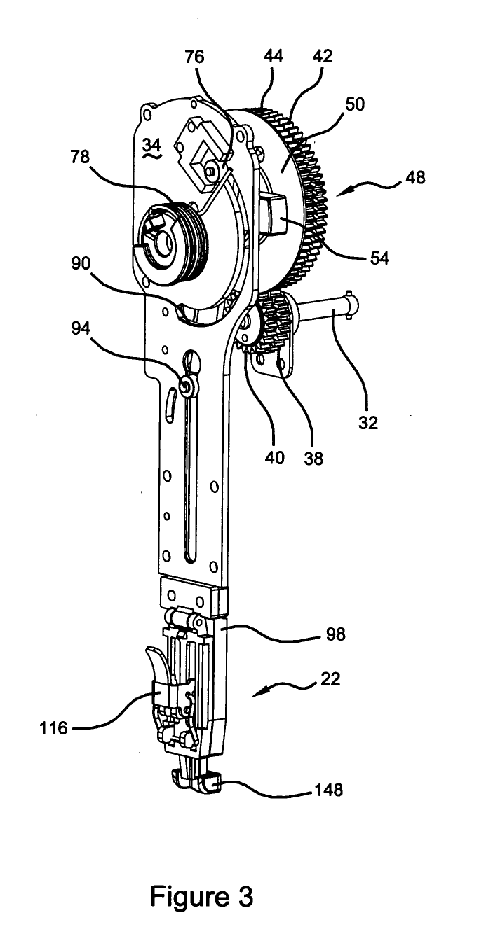

With reference to FIG. 2, a driveshaft 32 can connect an input (not specifically shown) of the transmission 16 to an output (not specifically shown) of the motor 14. A transmission housing 34 can encase the transmission 16, a portion of a driveshaft 32 and various components of the transmission 16. A driveshaft bearing 36 can be employed to journally support the driveshaft 32 in the transmission housing 34. With reference to FIGS. 2 and 3, the transmission 16 can include a first drive gear 38 and a second drive gear 40 that can be coupled for rotation with the driveshaft 32 within the transmission housing 34. The first drive gear 38 can be closer to the motor 14 relative to the second drive gear 40. It will be appreciated that the driveshaft 32, the first drive gear 38 and the second drive gear 40 can rotate at the same rotational speed.

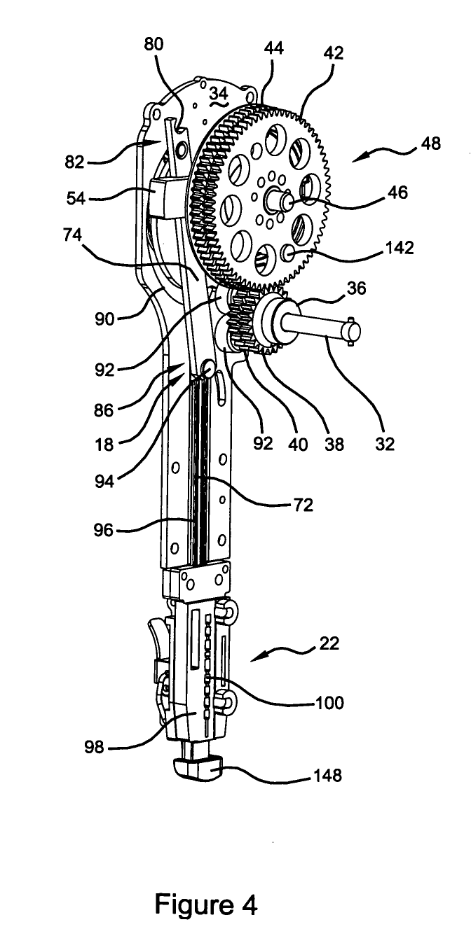

With reference to FIGS. 3 and 4, the transmission 16 (FIG. 2) can also include a flywheel 42 and a cam gear 44 that can be mounted for rotation on a transmission shaft 46. The first drive gear 38 can meshingly engage and drive the flywheel 42 while the second drive gear 40 can meshingly engage and drive the cam gear 44. The flywheel 42, the cam gear 44, the first drive gear 38 and the second drive gear 40 can form a transmission gear set 48. To that end, each gear of the transmission gear set 48 can be configured (e.g., by pitch diameter and/or by number of teeth) so that the flywheel 42 and the cam gear 44 rotate at different rotational speeds. The flywheel 42, for example, can rotate in response to rotation of the driveshaft 32 at a faster rotational velocity than the cam gear 44.

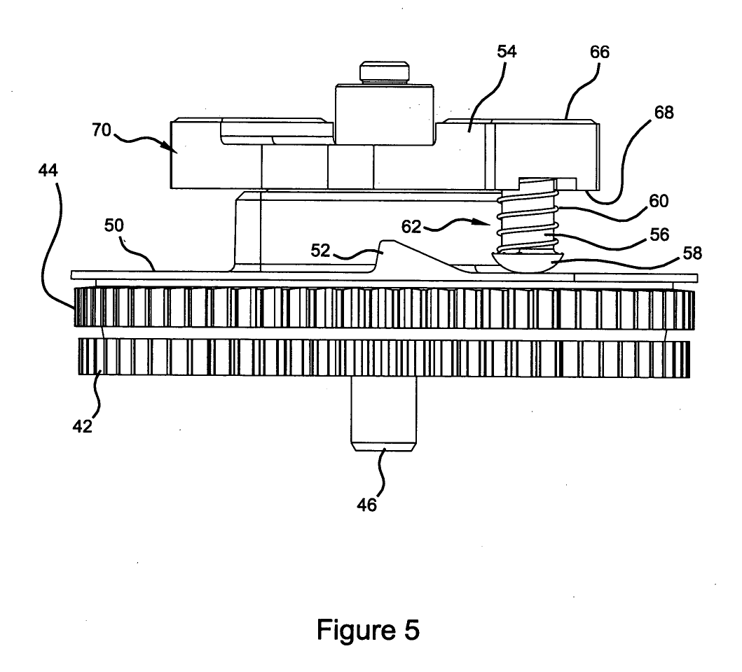

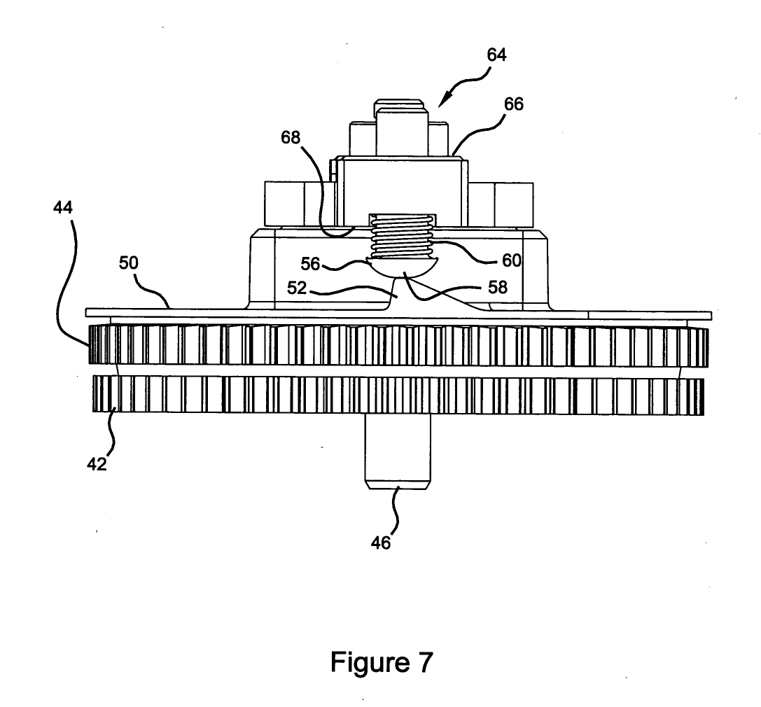

With reference to FIG. 5 through FIG. 8, the cam gear 44 can include a cover 50 defining a ramp 52. The cover 50 can fixedly connect to the cam gear 44 opposite the flywheel 42. The flywheel 42 can include a clutch arm 54 that can rotate with the remainder of the flywheel 42. The clutch arm 54 can be disposed on a side of the ramp 52 opposite the cam gear 44. The ramp 52 can be configured to engage a clutch pin 56 that is carried by the clutch arm 54, as shown in FIG. 7. For example, rotation of the cam gear 44 at a rotational velocity that is less than that of the flywheel 42 can cause a head 58 of the clutch pin 56 to advance toward or approach the ramp 52, as is illustrated in FIGS. 5 and 7. A clutch pin spring 60 can bias the clutch pin 56 into a retracted or a seated position 62, which is shown in FIG. 5. Contact between the ramp 52 and the clutch pin 56 can cause the clutch pin 56 to travel up the ramp 52 and push the clutch pin 56 outwardly from the clutch arm 54 from the seated position 62 into an extended position 64, as shown in FIG. 7.

It will be appreciated that when the clutch pin 56 is in the extended position 64, the clutch pin 56 can extend above a face 66 of the clutch arm 54 in a direction opposite the cover 50. In the seated position 62, the clutch pin 56 can extend below an opposite clutch arm face 68, which can be adjacent to the cover 50. It will also be appreciated that the clutch arm 54 can be counter-balanced such that the clutch pin 56 is radially spaced apart from a center of the transmission shaft 46. The opposite side of the clutch arm 54, which can counter-balance the clutch pin 56 with a suitable weight 70, is distal from the clutch pin 56.

When the clutch pin 56 contacts the ramp 52, the ramp 52 pushes the clutch pin 56 into the extended position 64, as shown in FIG. 7. In the extended position 64, the clutch pin 56 engages the driver mechanism 18. It will be appreciated that the extended position 64 can coincide with placement of the clutch pin 56 along any part of the ramp 52 that permits the clutch pin 56 to extend from the clutch arm 54 by a distance that is sufficient to engage the driver mechanism 18.

The driver mechanism 18 includes a driver blade 72 that connects to a crank link 74. The crank link 74 includes a crank link cam 76 (FIG. 3). The driver mechanism 18 also includes a crank link return-spring 78 (FIG. 3) that can connect to the crank link cam 76. The clutch pin 56 can engage the crank link 74 at a pin catch 80 (FIG. 4) and can drive the crank link 74 from a first position 82 to a second position 84. The motion of the crank link 74, in turn, moves the driver blade 72 from a top position 86 to a bottom position 88. As the fastener 28 in the nosepiece 22 is located in the driver blade's 72 path of travel, the driver blade 72 can insert (i.e., drive) the fastener 28 into the work-piece 30 (FIG. 1) as it travels to the bottom position 88.

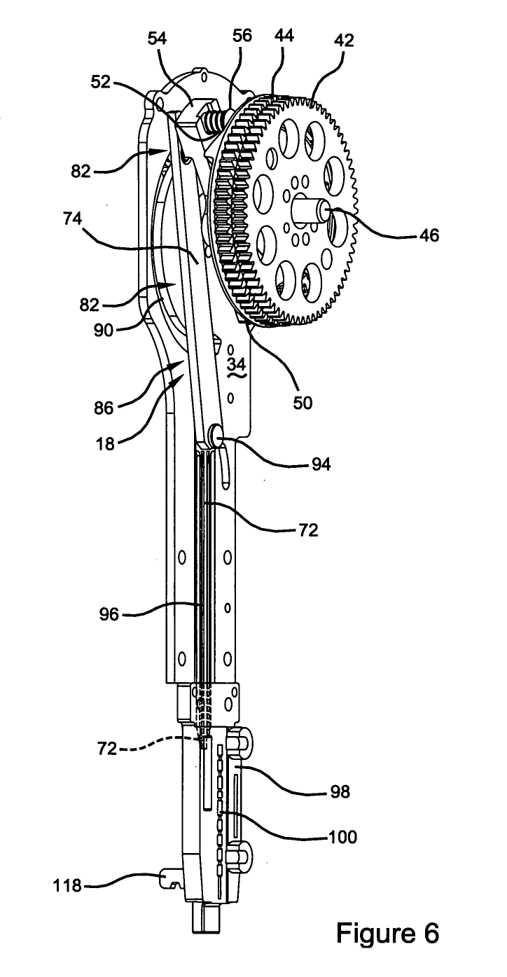

When the clutch pin 56 rotates beyond the ramp 52, the clutch pin spring 60 pushes the clutch pin 56 back into the seated position 62. When the clutch pin 56 is no longer engaging the crank link 74, the crank link return-spring 78 (FIG. 3) can return the crank link 74 to the first position 82, as shown in FIG. 6. The crank link cam 76 can be disposed in a link track 90 on the transmission housing 34. The crank link return-spring 78 can urge (bias) the crank link cam 76 along the link track 90 toward the first position 82. When the crank link 74 returns to the first position 82, the fastening tool 10 has completed a driver sequence.

It will be appreciated that the driver sequence can include the clutch pin 56 engaging the pin catch 80 and driving the crank link 74; the driver blade 72 translating from the first and top positions 82, 86 to the second and bottom positions 84, 88; the clutch pin 56 disengaging the pin catch 80; and the crank link return-spring 78 urging the crank link cam 76 upwardly in the link track 90 to cause the crank link 74 and the driver blade 72 to return to the first and top positions 82, 86, which can complete the driver sequence.

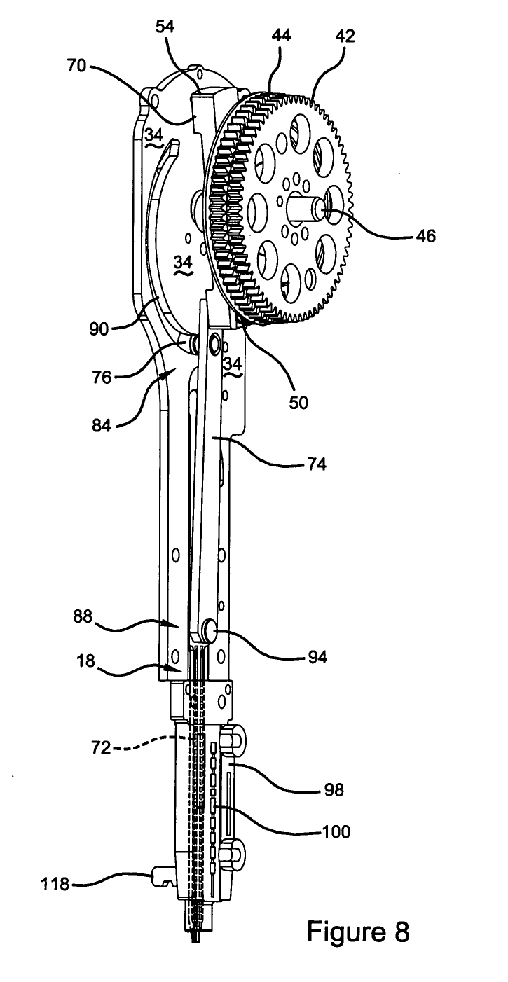

With reference to FIGS. 4 and 8, it will be appreciated that the crank link 74 can be configured such that travel beyond the second position 84 can be limited by, for example, one or more resilient bumpers 92. The clutch pin 56 (FIG. 5), therefore, can disengage from the crank link 74 at the bottom position 88. It will also be appreciated that a link joint 94 can pivotally connect the crank link 74 and the driver blade 72. The link joint 94 can allow the crank link 74 to travel in an approximately circular path, while the driver blade 72 travels in a vertical path (i.e., up and down). Moreover, a blade channel 96 can be employed to confine the driver blade 72 for movement along a desired axis to ensure travel in an up and down direction.

With reference to FIGS. 1, 9A, 9B and 10, the nosepiece 22 can include a magazine front 98 that can connect to the transmission housing 34 and the fastener magazine 24. The fastener magazine 24 can hold a plurality of the fasteners 28 and can sequentially advance the fasteners 28 through a fastener aperture 100 formed in the magazine front 98. A portion of the blade channel 96 can be formed in the magazine front 98 and can intersect the fastener aperture 100. The fastener 28 can travel through the fastener aperture 100 into the blade channel 96. The driver blade 72 can travel down the blade channel 96 and strike the fastener 28 that is residing in the blade channel 96 to drive the fastener 28 into the work-piece 30.

The fastener aperture 100 can have an aperture top 102a and an aperture bottom 102b, both of which can connect to the blade channel 96. The aperture bottom 102b can be configured to be shorter than the aperture top 102a. A slide 104 can be formed in the blade channel 96 and have a slide top 104a that can connect to the aperture bottom 102b. The slide 104 can extend from the slide top 104a to a slide bottom 104b that can connect to a bottom 98a of the magazine front 98. It will be appreciated that the slide 104 can effectively increase a portion of a channel depth 106 of the blade channel 96 proximate the fastener aperture 100.

More specifically, the channel depth 106 proximate the aperture top 102a, which is indicated by reference numeral 106a, can be less than the channel depth 106 proximate the aperture bottom 102b, which is indicated by reference number 106b. Moreover, the channel depth 106 proximate the bottom 98a of the magazine front 98, which is indicated by reference numeral 106c, can be less than the channel depth 106b proximate the aperture bottom 102b. For example, the channel depth 106b proximate the aperture bottom 102b and the slide top 104a can be less than twice the channel depth 106c proximate the bottom 98a of the magazine front 98.

By way of example, the channel depth 106a, 106c proximate the aperture top 102 and the bottom 98a of the magazine 98 can be slightly larger than a thickness of a suitable fastener 28 (FIG. 1). The channel depth 106b proximate the aperture bottom 102b, however, can be slightly smaller than the thickness of two suitable fasteners 28. It will be appreciated that the channel depth 106, variation of the channel depth 106 throughout the blade channel 96 and the thickness of the fastener 28 can be specific to certain models of the fastening tool 10 (FIG. 1). By way of further example, the channel depth 106b proximate the aperture bottom 102b and the slide top 104a can be configured to not permit more than one fastener 28 from entering the blade channel 96 below the fastener aperture 100 (i.e. in a direction opposite the flange connector 114). It will also be appreciated that the slide 104 can be operable to guide a misaligned fastener into the blade channel 96

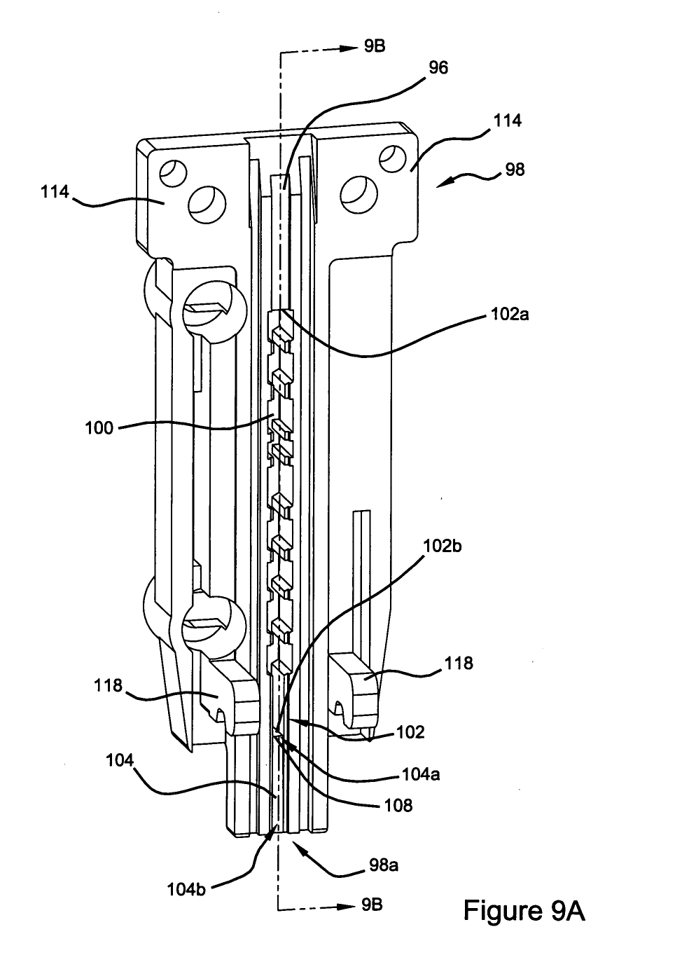

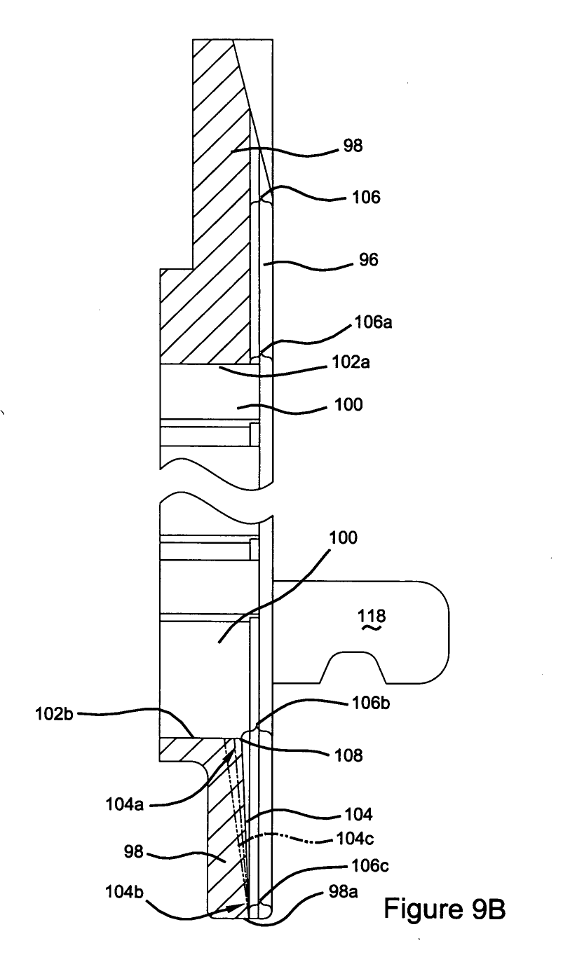

It will be appreciated that the slide 104 need not extend entirely through the blade channel 96. For example, the slide top 104a can begin at an intersection 108 of the aperture bottom 102b and the blade channel 96. By way of the above example, the slide 104 can extend from the intersection 108 diagonally downward (as illustrated in FIG. 9B) toward the bottom 98a of the magazine front 98. The slide bottom 104b can be located along the blade channel 96 where the slide 104 reaches the bottom 98a of the magazine front 98. In other examples, the slide bottom 104b can be located along the blade channel 96 prior to the slide 104 reaching the bottom 98a of the magazine front 98. It will also be appreciated that the slide 104 can have varying lengths and/or slopes and/or can occupy varying portions of the blade channel 96, as shown by reference numeral 104c in FIG. 9B.

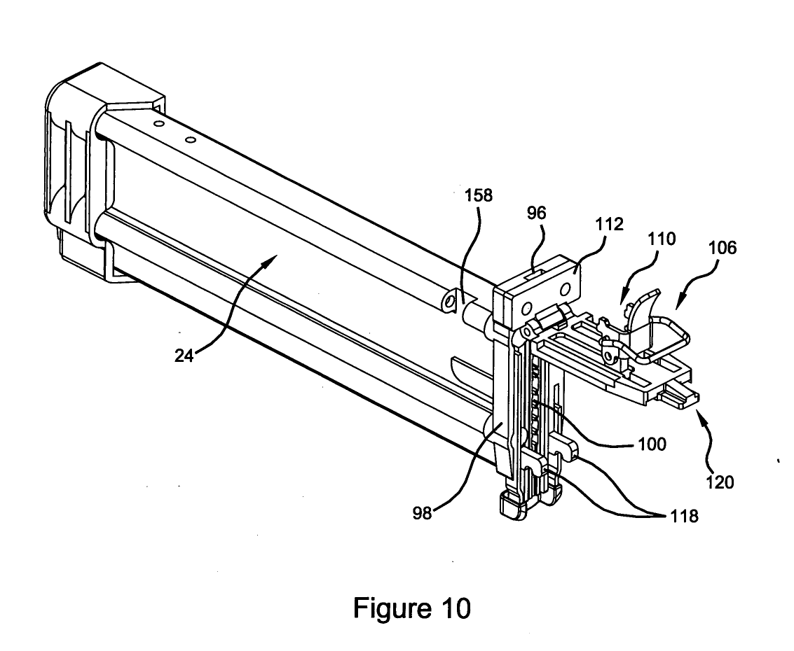

The nosepiece 22 can include a nosepiece cover 110 having a cover flange 112 that can connect to the magazine front 98 at a flange connector 114. The nosepiece cover 110 can also include a latch 116 that can couple to two tangs 118 formed on the magazine front 98. The latch 116 can be unlatched and the nosepiece cover 110 can rotate to a cover open position 120 (FIG. 10). A user (not shown) can unlatch and flip open the nosepiece cover 110 to remove a jammed fastener or other obstruction, for example.

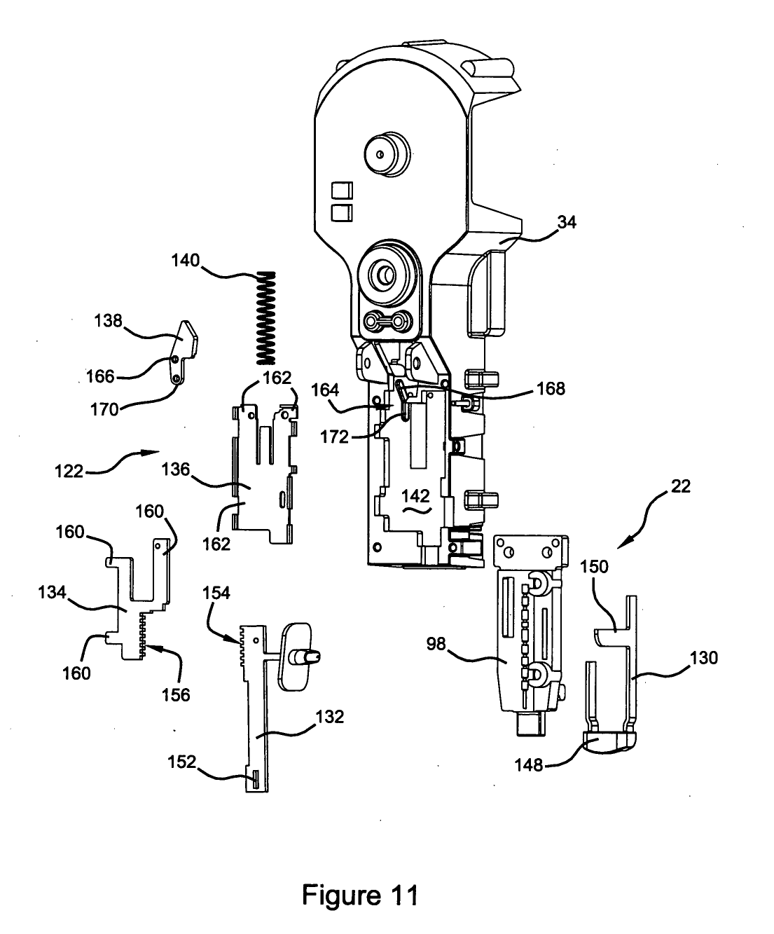

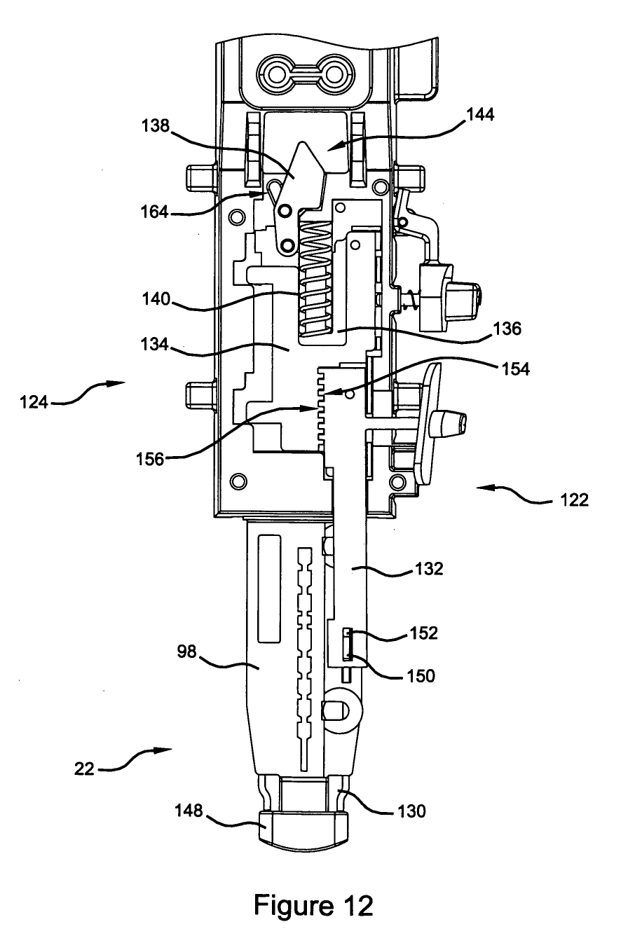

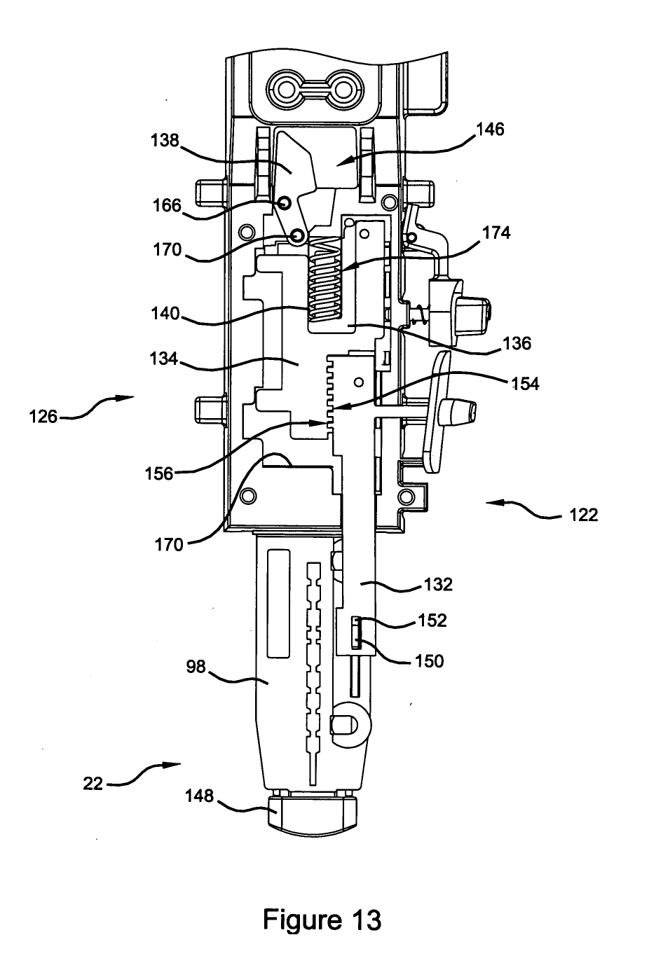

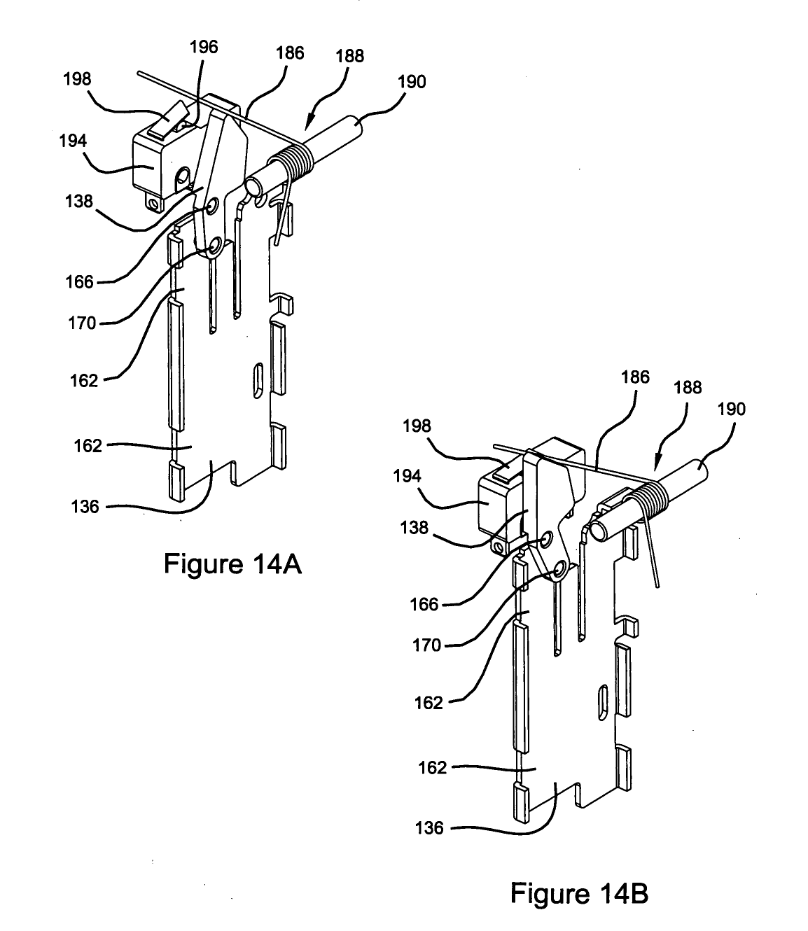

With reference to FIGS. 1 and 11-14B, the nosepiece 22 can include a contact trip mechanism 122 that is movable between an extended position 124, which is illustrated in FIG. 12, and a retracted position 126, which is illustrated in FIG. 13. The contact trip mechanism 122 can be configured to prevent the fastening tool 10 from executing the driver sequence unless the contact trip mechanism 122 is in the retracted position 126 (FIG. 13) (e.g., pressed against the work-piece 30).

The contact trip mechanism 122 can include a multi-component mechanical linkage that can connect the nosepiece 22 to a trigger assembly 128 (FIG. 2). The contact trip mechanism 122 can include a contact member 130 that connects to the magazine front 98 of the nosepiece 22. The contact member 130 can connect to a link member 132. The link member 132 can connect to a slider member 134. The slider member 134 can connect to a carrier member 136. The carrier member 136 can connect to a trigger block 138. The carrier member 136 can also connect to a contact trip spring 140. The carrier member 136 and the contact trip spring 140 can connect to a carrier depression 142 formed in the transmission housing 34. By way of example, when the contact member 130 is pushed against the work-piece 30, the contact member 130 moves up (i.e., toward the flywheel 42). When the contact member 130 moves up, the contact trip mechanism 122 can move into the retracted position 126. In the retracted position 126, the trigger block 138 can pivot from a blocked position 144 to an unblocked position 146.

More specifically, the contact member 130 can include a bumper 148 that can be configured to contact the work-piece 30. The bumper 148 can be made of rubber or another elastomeric material. The contact member 130 also includes a nose-link portion 150 that can extend approximately orthogonally to a remainder of the contact member 130. The nose-link portion 150 can fit into a nose-link aperture 152 formed on the link member 132. The link member 132 also includes a plurality of teeth 154 that are distal from the nose-link aperture 152. The plurality of teeth 154 on the link member 132 can engage with a plurality of teeth 156 on the slider member 134. The plurality of teeth 154 formed on the link member 132 can be disposed within the carrier depression 142 formed on the transmission housing 34. The link member 132 can extend beneath the transmission housing 34 and through a notch 158 (FIG. 10) formed on the fastener magazine 24 so that the nose-link aperture 152 can be positioned in-line with the nose-link portion 150 of the contact member 130. In this arrangement, the contact member 130 and the link member 132 can move relative to the fixed magazine front 98.

It will be appreciated that the plurality of teeth 154 can disengage from the plurality of teeth 156 and then can be reengaged at a different location to change the effective length of the contact trip mechanism 122. The effective length of the contact trip mechanism 122 can provide a depth adjustment function for the fastening tool 10, whereby the user can control the depth that the fastening tool 10 drives the fastener 28 into the work-piece 30. A depth adjustment mechanism is outside the scope of the present disclosure, but is disclosed in greater detail in commonly assigned United States Patent Application entitled Operational Lock and Depth Adjustment for Fastening Tool, filed herewith on ______, Serial Number ______, which is hereby incorporated by reference as if fully set forth herein.

The slider member 134 can include projecting portions 160 that can be received into corresponding recesses 162 that can be formed on the carrier member 136. The trigger block 138 can connect to the carrier member 136 and a trigger block track 164. More specifically, the trigger block 138 can include a block pin 166 that can travel in a first portion 168 of the trigger block track 164. The trigger block 138 can also include a block connecter pin 170 that can pivotally connects the trigger block 138 to the carrier member 136. The block connector pin 170 can extend through the carrier member 136 and into a second portion 172 of the trigger block track 164. Movement of the contact trip mechanism 122 into the retracted position 126 can cause the carrier member 136 to urge the trigger block 138 upwardly, while the trigger block track 164 can cooperate with the block pin 166 and the block connector pin 170 to pivot the trigger block 138 about the block connector pin 170. Accordingly, movement of the contact trip mechanism 122 into the retracted position 126 moves to the trigger block 138 into the unblocked position 146 as shown in FIG. 13. It will be appreciated that when the contact trip mechanism 122 is in the retracted position 126, the contact trip spring 140 is in a compressed position 174 (i.e., against the bias of the contact trip spring 140) and the trigger block 138 is in the unblocked position 146.

When the contact trip mechanism 122 is in the extended position 124 (e.g., no longer pressed against the work-piece 30), the contact trip spring 140 can push the carrier member 136 to a bottom 176 of the carrier depression 142. When the contact trip mechanism 122 is in the extended position 124, the trigger block pin 166 can be located near or in the second portion 172 of the trigger block track 164 such that the trigger block 138 is in the blocked position 144 (FIG. 12).

With reference to FIGS. 1 and 2, the trigger assembly 128 can mount to the transmission housing and can extend through the exterior housing 12. The trigger assembly 128 and can include a trigger 178 that can be biased into an extended position 180 (FIG. 1). The user can move (i.e., pivot and/or translate) the trigger 178 into an activated position 182 (FIG. 2). When the trigger 178 is in the activated position 182 and the trigger block 138 is in the unblocked position 146, the trigger 178 can activate a trigger switch 184 and can cause the trigger switch 184 to generate a trigger signal (not shown). When the trigger 178 activates the trigger switch 184, the fastening tool 10 can execute the driver sequence. Electronic control of the fastening tool 10 and the communication to and/or from the control module 20 (e.g., transmission and receipt of the trigger signal) is outside the scope of the present disclosure but is disclosed in greater detail in commonly assigned United States Patent Application entitled Electronic Control of a Cordless Fastening Tool, filed herewith on ______, Serial Number ______, which is hereby incorporated by reference as if fully set forth herein.

With reference to FIGS. 12, 13, 14A and 14B, a trigger actuation member 186 can be employed to couple the trigger 178 to the trigger switch 184. The trigger actuation member 186 can be, for example, a torsion spring 188 that can be mounted/coupled to a pivot pin 190. When the contact trip mechanism 122 is in the extended position 124, however, the trigger block 138 is positioned in the blocked position 144 and inhibits the trigger actuation member 186 from contacting the trigger switch 184. More specifically, when the contact trip mechanism 122 is in the extended position 124 and the user moves the trigger 178 to the activated position 182, the trigger block 138 is interposed between the trigger actuation member 186 and the trigger switch 184 and thereby blocks the trigger actuation member 186 from contacting the trigger switch 184 to prevent the execution of the driver sequence. When, however, the user moves the trigger 178 into the activated position 182 (FIG. 2) and the contact trip mechanism 122 is in the retracted position 126 (FIG. 13), the trigger block 138 is not interposed between the trigger actuation member 186 and the trigger switch 184 and as such, the trigger actuation member 186 is able to contact the trigger switch 184 to initiate the execution of the driver sequence.

Optionally, the fastening tool 10 can have an operational lockout mechanism 192 that can also inhibit the fastening tool 10 from executing the driver sequence, as shown in FIG. 1. The operational lockout mechanism 192 is outside the scope of the present disclosure, but is disclosed in greater detail in commonly assigned United States Patent Application entitled Operational Lock and Depth Adjustment for a Fastening Tool, filed herewith on ______, Serial Number ______, already incorporated by reference. Briefly, the operational lockout mechanism 192 can be configured to hold the trigger actuation member 186 away from the trigger switch 184, when the user switches the operational lockout mechanism 192 into a lock-out position.

With continued reference to FIGS. 12 and 13, the trigger switch 184 can be any suitable type of switch including, but not limited to, a micro switch. The trigger switch 184 can include a trigger switch body 194 and a trigger switch actuator 196. It can be appreciated that the trigger actuation member 186 can contact the trigger switch body 194 and that this contact does not operate to activate the trigger switch 184. Rather, actuation of the trigger switch 182 is effected through contact between the trigger actuation member 184 and the trigger switch actuator 196 and/or an actuator lever 198. By way of the above example, the trigger block 138 can deflect the trigger actuation member 186 from the trigger switch actuator 196 when the trigger block 138 is in the blocked position 144, but the trigger actuation member 186 may still contact the trigger switch body 194.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A fastening tool that inserts a fastener into a work-piece, the fastening tool comprising:
a trigger;
an actuation member connected to said trigger;
a trigger switch;
a trigger block having a blocked position that inhibits said actuation member from actuating said trigger switch and an unblocked position that does not inhibit said actuation member from actuating said trigger switch.

2. The fastening tool of claim 1 wherein said trigger switch is the only switch in the fastening tool.

3. The fastening tool of claim 1 further comprising a contact trip mechanism that moves said trigger block to said unblocked position when said contact trip mechanism is in a retracted position.

4. The fastening tool of claim 1 further comprising a contact member having a soft bumper, said contact member is slidingly engaged with a magazine front of said nosepiece, wherein said soft bumper is configured to not mar the work-piece.

5. The fastening tool of claim 1 wherein a contact member moves said trigger block into said unblocked position when said contact member is pressed against the work-piece.

6. The fastening tool of claim 4 further comprising a link member connecting said contact member to a slider member, said slider member connecting said link member to a carrier member, said carrier member connecting said slider member to said trigger block.

7. The fastening tool of claim 1 wherein said trigger block in said blocked position holds said actuation member away from said trigger switch.

8. The fastening tool of claim 1 further comprising a trigger switch actuator included in said trigger switch, wherein contact with said trigger switch actuator executes a driver sequence.

9. The fastening tool of claim 8 wherein said trigger block in said blocked position prevents said actuation member from contacting said trigger switch actuator to execute said driver sequence.

10. The fastening tool of claim 9 wherein said trigger block in said blocked position holds said actuation member away from said trigger switch actuator.

11. The fastening tool of claim 1 further comprising a nosepiece, said nosepiece defines
a fastener aperture through which the fastener passes,
a driver blade channel and
a slide partially defining said fastener aperture and said driver channel, wherein said slide is operable to guide the fastener that is misaligned into said driver blade channel.

12. A fastening tool comprising:
a trigger;
a contact trip mechanism;
a single switch that executes a driver sequence of the fastening tool when said trigger is positioned in an activated position and said contact trip mechanism is positioned in a retracted position.

13. The fastening tool of claim 12 further comprising a trigger block interposed between a actuation member that is connected to said trigger and associated with said single switch when said contact trip mechanism is in an extended position.

14. The fastening tool of claim 13 wherein said contact trip mechanism moves said trigger block to an unblocked position when said contact trip mechanism is in said retracted position.

15. The fastening tool of claim 13 wherein said trigger block in a blocked position holds said actuation member away from said single switch.

16. The fastening tool of claim 12 wherein said contact trip mechanism includes a contact member having a bumper, said contact member is slidingly engaged with a magazine front of a nosepiece, wherein said bumper is configured to not mar the work-piece.

17. A method of inhibiting activation of a driver sequence of a fastening tool, the method comprising:
providing a contact trip mechanism; and
blocking an actuation member from contacting a trigger switch, when said contact trip mechanism is in an extended position.

18. The method of claim 17 further comprising moving a trigger block to a non-blocking position when said contact trip mechanism is in a retracted position.

19. A fastening tool having a fastener magazine including a fastener, the fastening tool comprising:
a nosepiece defining a fastener aperture through which the fastener passes from the fastener magazine;
a driver blade channel having formed in said nosepiece and having a channel depth, said driver blade channel intersecting with said fastener aperture, wherein the fastener passes through said fastener aperture from the fastener magazine into said driver blade channel; and
a slide formed from said nosepiece and partially defining said driver blade channel, said slide having a bottom portion distal from said fastener aperture and a top portion of said slide that connects to said fastener aperture, wherein said channel depth proximate said top portion of said slide is greater than said channel depth proximate said bottom portion of said slide, said slide operable to guide the fastener that is misaligned into said driver blade channel.

20. The fastening tool of claim 19 wherein said fastener aperture has an aperture bottom, said slide extending from said aperture bottom to a bottom of said nosepiece.

21. The fastening tool of claim 19 wherein said fastener aperture has an aperture bottom, said slide partially extending from said aperture bottom to a bottom of said nosepiece.

22. The fastening tool of claim 19 wherein said channel depth proximate to said top portion of said slide is greater than said channel depth proximate to said bottom portion of said slide.

23. The fastening tool of claim 22 wherein said channel depth proximate to said top portion of said slide is less than twice said channel depth proximate to said bottom portion of said slide.

24. The fastening tool of claim 19 wherein said channel depth proximate to said top portion of said slide is greater than said channel depth proximate to an aperture top of said fastener aperture.
